(19) United States
(12) Patent Application Publication
(10) Pub. No.: US 2004/0148098 A1
(43) Pub. Date: Jul. 29, 2004

(54) Navigation device

(75) Inventor: Norihisa Yato, Gamagori-city (JP)

Correspondence Address: POSZ & BETHARDS, PLC, 11250 ROGER BACON DRIVE, SUITE 10, RESTON, VA, 20190, US

(73) Assignee: DENSO CORPORATION

(21) Appl. No.: 10/726,591

(22) Filed: Dec. 4, 2003

(30) Foreign Application Priority Data
Jan. 24, 2003 (JP) 2003-16119

(51) Int. Cl. G01C 21/34

(52) U.S. Cl. 701/209; 701/204; 340/995.19

(57) ABSTRACT

A present time indicated by an internal clock A can be changed by an ECU. When a user inputs a starting position and a destination through a remote controller, the ECU computes an arrival time at the destination and displays the arrival time along with the present time on a touch display. Thereafter, when the user commands changing the present time, the ECU changes the present time indicated by the internal clock A by a given commanded period. The arrival time is simultaneously changed by the given commanded period.

### CROSS REFERENCE TO RELATED APPLICATIONS

This application is based on and incorporates herein by reference Japanese Patent Application No. 2003-16119 filed on Jan. 24, 2003.

### FIELD OF THE INVENTION

The present invention relates to a navigation device capable of providing time information according to user's movement crossing over a border between time standards.

### BACKGROUND OF THE INVENTION

It is disclosed in JP-A-H11-108685 that a device provides appropriate region information according to a region where a user of the device moves. Here, the device determines whether the user moves to a different country or state by detecting at given intervals a present position of the user based on radio waves from GPS satellites. When the user is determined to move to the different country or state, the device downloads the appropriate region information from a data center to provide it to the user. The appropriate region information includes currency information related to current money, legal information related to laws or traffic regulations, or operation information related to living or behavior.

Although the above device is very useful, it is not considered that the device is used in the United States of America or European countries where only a single time standard is not used. Namely in the U.S. or European counties, plural time standards are used, so that a user sometimes moves between regions which have the respective time standards. It is therefore necessary for a navigation device to change time based on a region to which the user moves. However, changing the time standard involves inconsistence with a previously estimated arrival time, which may result in confusing the user.

### SUMMARY OF THE INVENTION

It is an object of the present invention to provide a navigation device capable of providing time information according to a region where a user moves.

To achieve the above object, a navigation device is provided with the following. An arrival time at a destination is estimated by adding, based on indicated time, a period necessary for traveling along a route to the destination. Time can be designated. The indicated time can be changed into the designated time. Here, when the indicated time is changed by a given period, the arrival time is also changed based on the given period.

This structure enables an arrival time at a destination to be changed when a user moves to a given region that has a different time standard. When the user moves to the given region, the arrival time can be changed as being consistent with the time standard of the given region. This can prevent the user from being confused and provide appropriate time information according to user's movement.

In another aspect of the present invention, a navigation device is provided with the following. When a destination is designated, route guide to the designated destination is executed and an arrival time to the destination is estimated based on time standard which the designated destination uses. This enables a user to recognize an arrival time at a destination based on time standard that is used at the destination. This is very convenient for a user to plan activities around the destination.

### BRIEF DESCRIPTION OF THE DRAWINGS

The above and other objects, features, and advantages of the present invention will become more apparent from the following detailed description made with reference to the accompanying drawings. In the drawings:

FIG. 1 is a schematic block diagram showing an overall structure of a car navigation device according to a first embodiment of the present invention;

FIG. 2 is a diagram showing a present time change window displayed on a touch display of a car navigation device according to the first embodiment;

FIG. 3 is a flowchart diagram explaining processing of displaying a present time and an arrival time at a destination in a car navigation system according to the first embodiment;

FIG. 4 is a flowchart diagram explaining processing of changing a present time in a car navigation device according to the first embodiment;

FIG. 5 is a diagram showing an instance of a window on a touch display of a car navigation device according to the first embodiment just before a national boundary is overrun;

FIG. 6 is a diagram showing an instance of a window on a touch display of a car navigation device according to the first embodiment just after a national boarder is overrun;

FIG. 7 is a flowchart diagram explaining processing of changing a present time and an arrival time at a destination in a car navigation device according to a modification of the first embodiment;

FIG. 8 is a flowchart diagram explaining processing of computing an arrival time at a destination and displaying a present time and the arrival time in a car navigation device according to a second embodiment of the present invention;

FIG. 9 is a diagram showing an instance of a window on a touch display of a car navigation device according to the second embodiment just before a national boundary is overrun; and

FIG. 10 is a diagram showing an instance of a window on a touch display of a car navigation device according to the second embodiment just after a national boarder is overrun.

### DETAILED DESCRIPTION OF THE PREFERRED EMBODIMENTS

(First Embodiment)

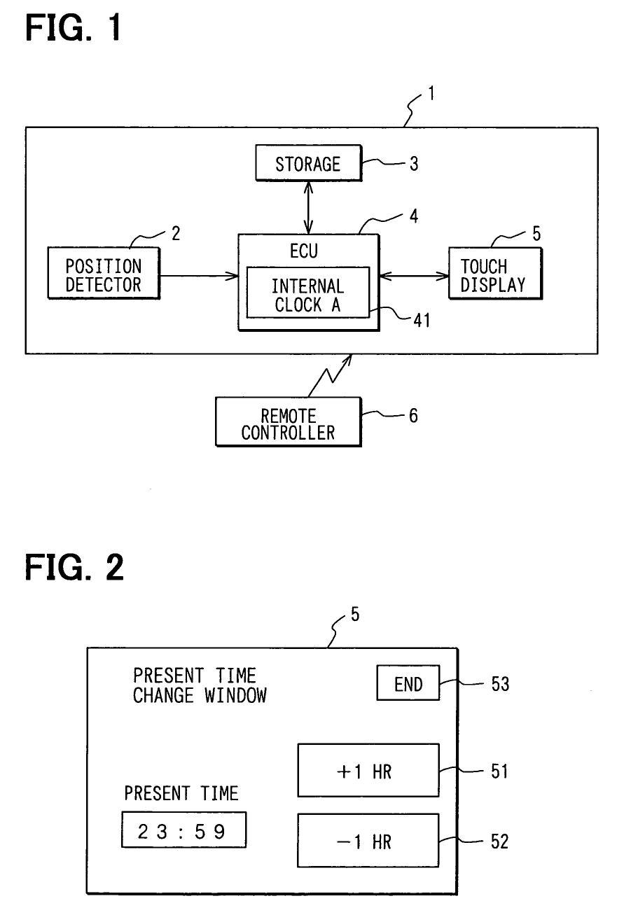

An overall structure of a navigation device according to a first embodiment of the present invention is shown in FIG. 1. The navigation device of the embodiment operates as a car navigation device 1 mounted in a vehicle.

The car navigation device 1 is equipped with a position detector 2, a memory storage 3, an electronic control unit (ECU) 4, a touch display 5, and a remote controller 6.

The position detector 2 includes a GPS receiver, a gyroscope, a G-sensor, or the like to detect a present position of the vehicle. Detecting the present position can be also realized based other sensors such as a steering sensor.

The memory storage 3 can be a hard disk. The memory storage 3 is for storing map data necessary for various navigating functions and a database being stored with averaged vehicle's passing periods related to various routes on a map. In particular, in the embodiment, the memory storage 3 is furthermore stored with a time difference database. The time difference database includes, of various worldwide regions, time differences between the respective regions' time standards and Greenwich Time Standard. The time difference database can be stored in a CD-ROM, a DVD-ROM, or the like.

The ECU 4, being an ECU for navigating, executes various navigating functions. By using the passing period database stored in the memory storage 3, a travel period necessary for reaching a destination is computed for estimating an arrival time at the destination.

In this embodiment, the ECU 4 possesses an internal clock A 41 indicating a present time. The present time indicated by the internal clock A 41 can be changed with the following procedure: a present time change window is displayed on the touch display 5 by the ECU 4 as shown in FIG. 2; and the present time of the internal clock A 41 is changed to be set forward or backward every an hour based on electric signals outputted from the touch display 5. Here, the arrival time at the destination is changed by as many hours as by which the present time of the internal clock A 41 is changed. Details of the change window shown in FIG. 2 will be explained later.

The touch display 5 is for displaying various navigating functions. In particular, in the embodiment, the touch display 5 displays the present time indicated by the internal clock A 41 and the arrival time at the destination computed by the ECU 4. The touch display 5 furthermore displays the present time change window shown in FIG. 2 and outputs to the ECU 4 a user's instruction related with changing of the present time.

In detail, as shown in FIG. 2, the present time, “+1 HR” key 51, “−1 HR” key 52, and “END” key 53 are displayed on the present time change window. Once a given key of the keys 51 to 53 is touched, an electric signal indicating that the given key is touched is outputted into the ECU 4. The touch display 5 of the embodiment also displays a window requesting inputting of a starting position and a destination. The present time indicated by the internal clock A 41 and the arrival time at the destination computed by the ECU 4 can be displayed on an in-vehicle head-up display or the like instead, or be outputted via speech through a speaker or the like. The instruction of changing can be also executed through the remote controller 6 or the like.

The remote controller 6, for instance, being a multi-functional remote controller formed of numeric keys and functional keys, is for instructing the car navigation device 1 to execute the various navigating functions. In this embodiment, the remote controller 6 is used for inputting a starting position or a destination or commanding changing of the present time. However, the preceding inputting or commanding can be executed by touching an input key or a command key displayed on the touch display 5.

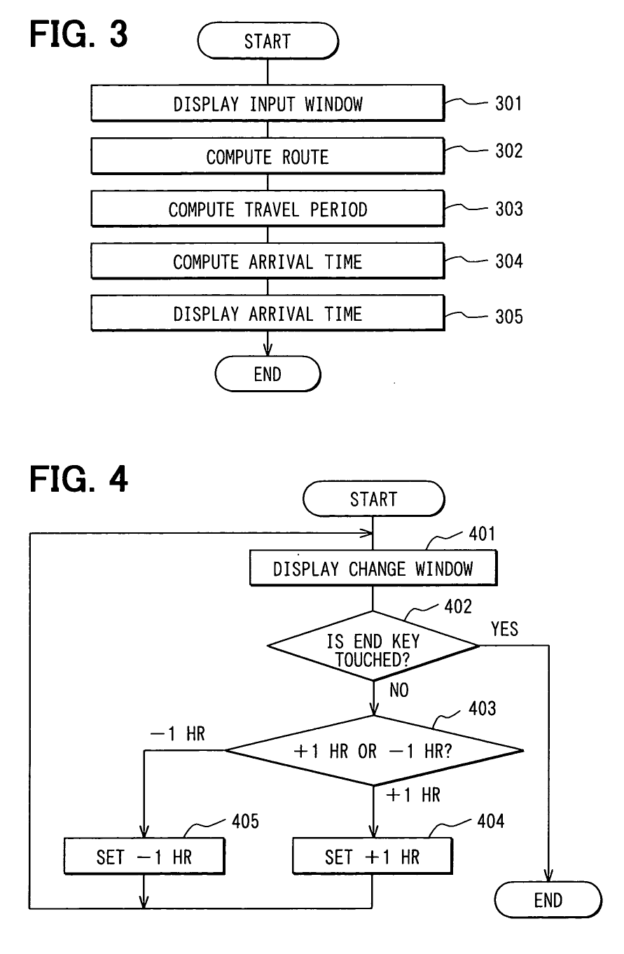

Processing of displaying a present time and an arrival time at a destination in a car navigation system according to the first embodiment will be explained below with reference to FIG. 3. The processing of this flowchart is executed each time a user pushes a destination designating key (not shown) of the remote controller 6.

At Step 301, the ECU 4 outputs on the touch display 5 a window requesting inputting of a starting position and a destination through the remote controller 6 to wait till inputting is completed.

At Step 302, using the map data stored in the memory storage 3, a travel route from the inputted starting position to the inputted destination is computed. Since in computing the travel route plural methods such as Dijkstra method are well known, explanation is eliminated.

At Step 303, the travel route computed at Step 302 is divided into plural routes. Passing periods corresponding to the respective divided routes are obtained from the passing period database stored in the memory storage 3 to be summed up to compute a travel period to the destination.

At Step 304, the present time is obtained from the internal clock A 41 and is added to the travel period computed at Step 303 to compute an arrival time at the destination.

At Step 305, the present time indicated by the internal clock A 41 and the arrival time computed at Step 304 are outputted to the touch display 5 for displaying.

Processing of changing a present time in a car navigation device will be explained below with reference to FIG. 4. The processing of this flowchart is executed each time a user pushes a present time changing key (not shown) of the remote controller 6.

At Step 401, the ECU 4 outputs on the touch display 5 a present time change window to wait till any one of “+1 HR” key 51, “−1 HR” key 52, and “END” key 53 is touched.

At Step 402, it is determined whether a key that is touched is “END” key 53. When the touched key is “END” key 53, the processing is terminated. When the touched key is not “END” key 53, the processing proceeds to Step 403.

At Step 403, it is determined whether the touched key is “1+1 HR” key 51 or “−1 HR” key 52. When the touched key is “+1 HR” key 51, the processing proceeds to Step 404. Here, the present time indicated by the internal clock A 41 and the arrival time at the destination are set forward by an hour and then the processing returns to Step 401. By contrast, when the touched key is “−1 HR” key 52, the processing proceeds to Step 405. Here, the present time indicated by the internal clock A 41 and the arrival time at the destination are set backward by an hour and then the processing returns to Step 401. This enables the user to easily change the present time indicated by the internal clock A 41 into time following a time standard used in a region where the user moves by touching “+1 HR” key 51 or “−1 HR” key 52.

As explained above, in the car navigation device according to the first embodiment, when the user changes the present time indicated by the internal clock A 41, based on the changed present time, the arrival time at the destination is also automatically changed. In the U.S. or European countries, plural time standards are used, so that a user sometimes moves between regions that use the respective time standards. Here, it is necessary to change time based on a region to which the user moves. However, changing the time standard involves inconsistence with a previously estimated arrival time, which may result in confusing the user. By using a car navigation device according to the embodiment, when the user changes the present time indicated by the internal clock A 41 into time following time standard used in a region to which the user moves, the arrival time at the destination can be changed based on the changed present time. Consistency between the present time and the arrival time at the destination can be maintained, so that the user is prevented from being confused. As a result, the navigation device is capable of providing appropriate time information according to user's movement.

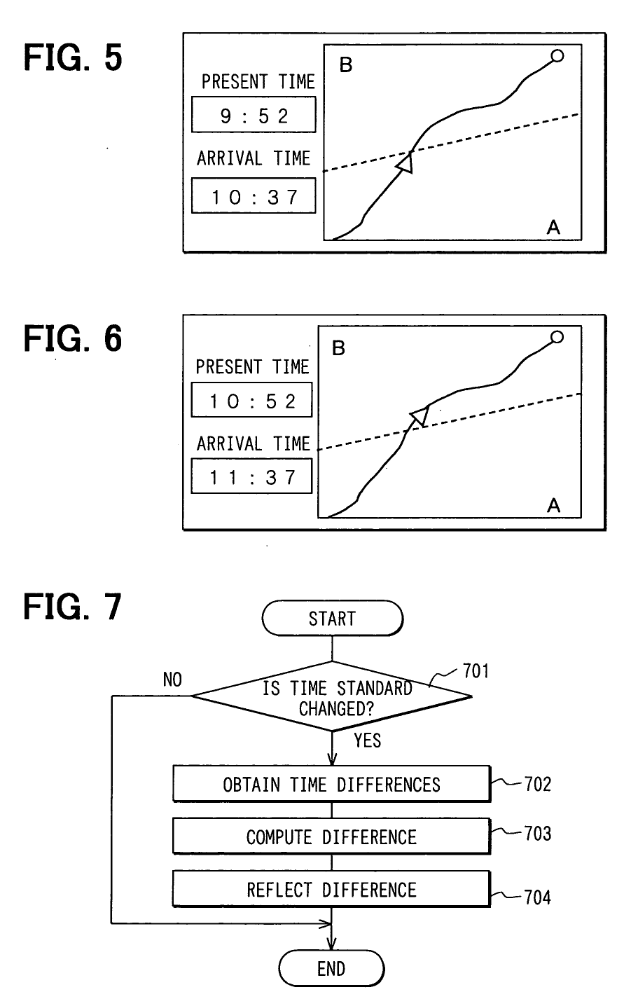

In the next place, an instance of displaying a present time and an arrival time at a destination will be explained below with reference to FIG. 5.

FIG. 5 shows an instance of a display window shown on the touch display 5 just before a vehicle having a navigation device according to the first embodiment passes through a national border. The window includes time display portions of a present time and an arrival time and a map display portion. In the map display portion, Mark A shows a vehicle's present position, while Mark 0 shows a destination. A solid line shows a travel route, while a dotted line shows the national border between Country A and Country B. A difference period between time standards used in Country A and Country B is one hour. Time in Country B gains one hour over time in Country A. In FIG. 5, the present time shows 9:52, while the arrival time shows 10:37. It means that a travel period from the present position to the destination is 45 minutes.

FIG. 6 shows an instance of a display window shown on the touch display 5 when a user sets the present time forward by an hour just after the vehicle having the navigation device according to the first embodiment passes through the national border from Country A to Country B. The present time is set forward by an hour and shows 10:52. The arrival time is also set forward by an hour and shows 11:37. The travel period thereby remains 45 minutes.

A modification of the first embodiment will be explained below with reference to FIG. 7. Here, by comparison to the first embodiment, a present time indicated by the internal clock A 41 and an arrival time at a destination are automatically changed according to user's movement.

FIG. 7 is a flowchart diagram explaining processing of changing a present time and an arrival time at a destination in a car navigation device according to the modification of the first embodiment. The processing of the flowchart is executed at given intervals.

At Step 701, the ECU 4 determines whether a vehicle having the navigation device moves from a certain region using a certain time standard into a given region using a different given time standard based on a vehicle's present position detected by the position detector 2. When the vehicle moves into the given region, the processing proceeds to Step 702. Otherwise, the processing is terminated.

At Step 702, a time difference between the certain time standard and Greenwich Time Standard and a time difference between the given time standard and Greenwich Time Standard are obtained from the time difference database. At Step 703, a difference period between the two time differences is computed.

At Step 704, the difference period computed at Step 703 is reflected on the present time and the arrival time by increasing or decreasing by the difference period.

Through the above processing, when the vehicle moves into a region using a different time standard, the user does not need to check time differences. This enhances user's convenience. Furthermore, time indicated by the internal clock A 41 can be accurately set as following the time standard used in the region where the user of the vehicle moves.

(Second Embodiment)

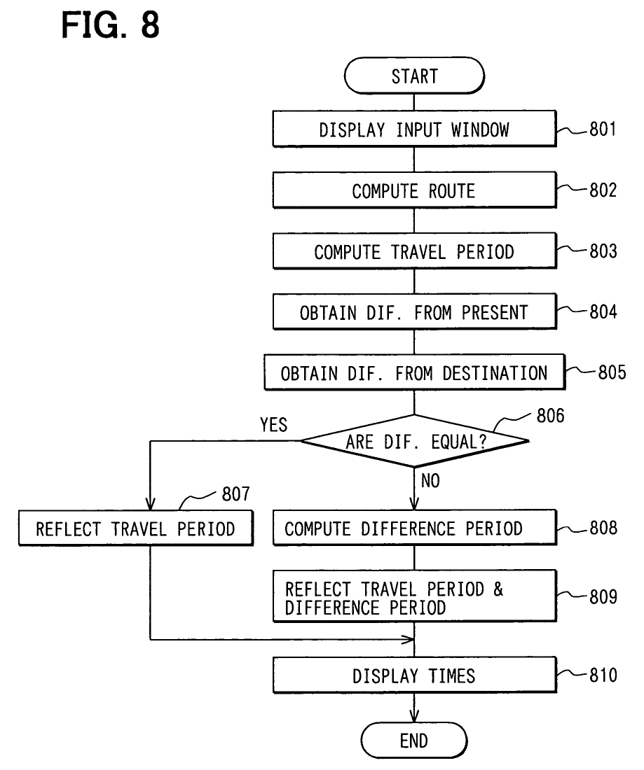

FIG. 8 shows processing of computing an arrival time at a destination and displaying a present time and the arrival time in a car navigation device according to a second embodiment of the present invention. The processing of this flowchart is executed each time a user pushes a destination designating key (not shown) of the remote controller 6.

At Step 801, the ECU 4 outputs on the touch display 5 a window requesting inputting of a starting position and a destination through the remote controller 6 to wait till inputting is completed.

At Step 802, using the map data stored in the memory storage 3, a travel route from the inputted starting position to the inputted destination is computed. Since in computing the travel route plural methods such as Dijkstra method are well known, explanation is also eliminated.

At Step 803, the travel route computed at Step 802 is divided into plural routes. Passing periods corresponding to the respective divided routes are obtained from the passing period database stored in the memory storage 3 to be summed up to compute a travel period to the destination.

At Step 804, a first time difference between a certain time standard used in a present region and Greenwich Time Standard is obtained from the time difference database based on a vehicle's present position detected by the position detector 2.

At Step 805, a second time difference between a given time standard used in the destination set at Step 801 and Greenwich Time Standard is obtained from the time difference database.

At Step 806, it is determined whether the first time difference is equal to the second time difference. When the two time differences are the same, the processing proceeds to Step 807. An arrival time at the destination is computed by adding the travel period computed at Step 803 to the present time indicated by the internal clock A 41.

By contrast, when the two time differences are not the same, the processing proceeds to Step 808. Here, a difference period between the first and second time differences obtained at Steps 804, 805 is computed. Thereafter, at Step 809, an arrival time at the destination is computed by adding the difference period computed at Step 808 and the travel period computed at Step 803 to the present time indicated by the internal clock A 41.

At Step 810, the present time indicated by the internal clock A 41 and the arrival time computed at Step 807 or 809 are outputted to the touch display 5 for displaying.

As explained above, in the car navigation device according to the second embodiment, an arrival time at a destination designated by a user is computed based on a time standard used in the destination and displayed on the touch display 6 along with a present time and a travel period to the destination. As above-mentioned, in the U.S. or European countries, plural time standards are used, so that a user sometimes moves between regions that use the respective time standards. In this case, it is preferable that an arrival time at the destination is provided based on a time standard used in the destination when user's activities around the destination are considered. The navigation device of the second embodiment enables the user to recognize an arrival time at the destination following the time standard used in the destination and to thereby grasp relation with the activities around the destination.

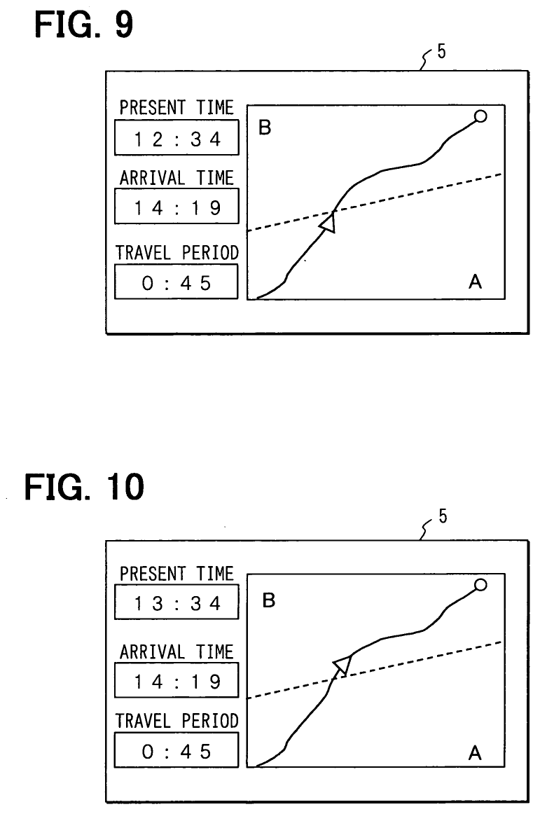

In the next place, an instance of displaying a present time and an arrival time at a destination will be explained below with reference to FIG. 9.

FIG. 9 shows an instance of a display window shown on the touch display 5 just before a vehicle having a navigation device according to the second embodiment passes through a national border. The window includes a map display portion and time display portions of a present time, an arrival time, and a travel period. In the map display portion, Mark Δ shows a vehicle's present position, while Mark O shows a destination. A solid line shows a travel route, while a dotted line shows the national border between Country A and Country B. A difference period between time standards used in Country A and Country B is one hour. Time in Country B gains one hour over time in Country A. In FIG. 9, the present time shows 12:34, while the arrival time shows 14:19 in the time standard used in Country B. The travel period of 45 minutes is also shown.

FIG. 10 shows an instance of a display window shown on the touch display 5 when a user sets the present time forward by an hour just after the vehicle having the navigation device according to the second embodiment passes through the national border from Country A to Country B. The present time is set forward by an hour and shows 13:34. By contrast, the arrival time remains 14:19 in similarly in FIG. 9. The travel period naturally remains 45 minutes.

The above-mentioned embodiments can be used respectively or by combining all or some of them.

In the above embodiment, although changing time (increasing or decreasing time) is executed every an hour, it can be also every half of an hour, i.e., “+0.5 HR” or “−0.5 HR”.

Furthermore, a navigation device of the present invention is the most appropriately directed to a car navigation device mounted in a vehicle. However, it is not limited to the car navigation device, but also is directed to any device for moving between regions having different time standards. For instance, the present invention can be directed to a device used in a railway, a ship, an airplane, or the like.

It will be obvious to those skilled in the art that various changes may be made in the above-described embodiments of the present invention. However, the scope of the present invention should be determined by the following claims.

What is claimed is:

1. A navigation device comprising:
a time indicating unit for indicating time;
an arrival time estimating unit for estimating an arrival time at a destination by adding, based on the time indicated by the time indicating unit, a period necessary for traveling along a route to the destination;
a time designating unit for designating time; and
a time changing unit for changing the time indicated by the time indicating unit into the time designated by the time designating unit,
wherein, when the time indicated by the time indicating unit is changed into the time designated by the time designating unit by a given period, the arrival time estimating unit changes the arrival time based on the given period.

2. The navigation device of claim 1,
wherein the time designating unit designates the time which gains or loses every an hour with respect to the time indicated by the time indicating unit.

3. The navigation device of claim 1, further comprising:
a time standard detecting unit for detecting moving to a region that has a different time standard,
wherein the time designating unit includes a computing unit for computing time following a time standard of a region, and
wherein, when the time standard detecting unit detects moving to a region that has a different given time standard, the time designating unit computes given time following the given time standard to thereby designate the given time into which the time changing unit changes the time indicated by the indicating unit.

4. A navigation device comprising:
a destination designating unit for designating a destination to which route guide is executed;
a route guiding unit for executing route guide to the designated destination; and
an arrival time estimating unit for estimating, when the destination is designated, an arrival time at the designated destination based on a time standard of the designated destination.

5. The navigation device of claim 4, further comprising:
a travel period displaying unit for computing and displaying a travel period to the designated destination when the destination is designated.

6. The navigation device of claim 1,
wherein the navigation device is mounted in a vehicle.

7. The navigation device of claim 4,
wherein the navigation device is mounted in a vehicle.

8. A time changing method used in a navigation device that includes:
a time indicating unit for indicating time; and
an arrival time estimating unit for estimating an arrival time at a destination by adding, based on the time indicated by the time indicating unit, a period necessary for traveling along a route to the destination,
the time changing method comprising:
a first step of designating time; and
a second step of changing the time indicated by the time indicating unit into the time designated at the second step,
wherein, when the time indicated by the time indicating unit is changed into the time designated at the first step by a given period, the arrival time estimating unit changes the arrival time based on the given period.
